(19) United States
(12) Patent Application Publication
(10) Pub. No.: US 2014/0181248 A1
(43) Pub. Date: Jun. 26, 2014

(54) Simple Remote Access Through Firewalls For Networked Devices and Applications

(71) Applicants: Jonathan Peter Deutsch, San Jose, CA (US); Danny Te-An Sung, Rancho Santa Margarita, CA (US); Daryl R. Miller, Rancho Santa Margarita, CA (US); David L. Wagstaff, Lake Forest, CA (US); Kaori Kuwata, San Juan Capistrano, CA (US)

(72) Inventors: Jonathan Peter Deutsch, San Jose, CA (US); Danny Te-An Sung, Rancho Santa Margarita, CA (US); Daryl R. Miller, Rancho Santa Margarita, CA (US); David L. Wagstaff, Lake Forest, CA (US); Kaori Kuwata, San Juan Capistrano, CA (US)

(21) Appl. No.: 13/876,438

(22) PCT Filed: Sep. 27, 2010
(86) PCT No.: PCT/US10/50428

§ 371 Date: Jun. 7, 2013

(51) Int. Cl. H04L 29/06

(52) U.S. Cl. CPC H04L 65/608
USPC 709/217

(57) ABSTRACT

A method, apparatus, and system are described for accessing networked devices without accessible network addresses via Virtual IP (VIP) addresses. The system consists of a soft Device Services Controller (DSC), downloaded on a first local network from the device service manager (DSM) on a wide area network, and a VIP Access enabled device on a second local network separate from the first area network. The soft DSC and associated VIP Access enabled device create a virtual network interface and corresponding virtual IP address (VIP) to permit outgoing TCP/IP conduit connection to the DSM. When networking traffic arrives at the virtual networking interface with the associated VIP, the soft DSC automatically processes and forwards that traffic to the DSM. Using this mechanism, it is possible for two networked devices on separate networks to communicate in spite of firewalls and without knowledge of each other's network.

### RELATED APPLICATIONS

This application claims the benefit of U.S. PCT Patent Application No. PCT/US2008/081191 filed on Oct. 24, 2008 and U.S. Provisional Patent Application Ser. No. 60/982,388, entitled “Means Of Providing Virtual IP Address To Automatically Access Remote Network Devices” filed Oct. 24, 2007.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office patent file or records, but otherwise reserves all copyright rights whatsoever.

### FIELD OF THE INVENTION

Embodiments of the invention generally relate to network devices. More particularly, an aspect of an embodiment of the invention relates to access to and from networked devices via use of virtual Internet Protocol (IP) addresses.

### BACKGROUND OF THE INVENTION

The Internet is a large collection of networks that collectively use the TCP/IP protocol suite to allow devices on one network to automatically communicate with other devices that may be on the same or remote networks. Each such device is assigned an IP address for each active network interface, which allows network infrastructure components to automatically route traffic between target devices.

It is a general requirement that each such network interface be assigned an IP address that is unique across the entire Internet, although several blocks of IP addresses have been reserved for use on interfaces that do not need to be made available outside the local network. Such private addresses are also referred to as “non-routable” addresses because it is not possible to establish a route (that is, a path through a set of network infrastructure devices) such that traffic from a device on the local network may reach a network interface with the non-routable address on a remote network. As the Internet has grown, this technique has allowed the repeated reuse of private addresses, which has helped to alleviate a growing shortage of publicly accessible IP addresses, but it has also lead to greater complexity as administrators sought alternative mechanisms to provide access to remote devices without routable addresses.

As the Internet has grown and security threats have increased, network administrators have also sought to limit access to specific devices under their administrative control by developing and deploying network filtering devices or applications that allow network administrators to specify specific address and port combinations that are granted or denied access, as required. Together, these two techniques have helped ensure the growth and stability of the Internet, but at the cost of greatly increased complexity and cost for administrators wishing to provide seamless access to networked devices on networks outside their administrative control.

One existing mechanism to address this problem involves installing dedicated client software on a local networked device that would allow it to function as part of a “Virtual Private Network” (VPN), in which the local device is allowed to act as if it is a member of the remote network. When using such a VPN system the local host is assigned an IP address on the remote network and all traffic to and from hosts on the remote network is automatically routed by the VPN system.

This technique works but the approach suffers from several shortcomings. A VPN system must first be set up by the administrator of the remote network. Once that is done, specialized software must be installed on each external device that wishes access or the VPN system (if this is not done, the system will be capable of providing only limited accessibility, for example via a web browser interface). In addition, appropriate security credentials must be generated by the remote administrator and distributed and maintained by the local administrator and users, all of which places a significant administrative burden on all parties to the operation. As a final drawback, once a local host is granted VPN access, it will generally have access to all devices on the remote network, unless additional filtering steps are taken to prevent this, which may not be desired by the remote administrator.

Another technique to overcome the problems of non-routable addresses is to perform so-called “network address translation” (NAT), which involves complex reconfiguration of border routers to automatically map network address/port combinations to and from routable to non-routable addresses. This technique does allow the use of a single publically routable IP address to provide access to multiple devices with non-routable addresses but only at the cost of increased system complexity. NAT-enabled networks do not generally allow incoming connections unless mappings have been pre-configured from specific port/address combinations to specific devices, which may in turn conflict with software that attempts to use default or non-standard address/port combinations.

Given these challenges, there exists a need for a mechanism to allow simplified and automated access to remote devices using non-routable addresses without the use of dedicated host software and without requiring network administrator privileges on the remote network to set up, maintain or operate the solution.

### SUMMARY OF THE INVENTION

A method, apparatus, and system are described that provides fully automated network access to remote networked devices that would otherwise be inaccessible because there does not exist a valid route to that device's network address. Note that the system may work without the use of dedicated host software and it does not require network administrator privileges on the remote network to set up, operate or maintain the system. Note, also that the system can coexist with existing VPN systems and is fully compatible with networks that are using network address translation to map one or more external addresses to non-routable addresses that would otherwise not be available outside the local network.

The system consists of three major components—the Host Controller, the Device Controller and the Device Services Manager (or DSM) (see FIG. 2a). The Host Controller consists of a component that is installed as a networking device on the local network. The Device Controller consists of a component that is installed as a networking device on the remote network and the Device Services Manager consists of a component that is installed on the Internet and that is accessible via direct network connections from both the Host Controller and the Device Controller. Observe that these components may all instantiate as either dedicated network hardware device components or as software components on a larger computing system, without loss of generality or functionality.

Both the Host Controller and the Device Controller must have the ability to establish outgoing data connections to the DSM. The DSM can then be used to relay traffic between the Host Controller and Device Controller components. These in turn are used to relay traffic between the originating and target networked devices

In practice, there may be a firewall device between the DSM and the Host Controller or Device Controller components which block either incoming connections or some combination of IP addresses or ports. In this case, if it is possible for the Host Controller and/or Device Controller to establish an outgoing TCP/IP session to the DSM, all other traffic in the system may then be automatically multiplexed onto these connections for transmission between the components for eventual delivery to the source or destination devices.

The purpose of the Host Controller is to act as a proxy access point for connections from originating networked devices on the local network to remote devices that would otherwise be inaccessible to the originating networked device. The purpose of the Device Controller is to act as a relay point for traffic being delivered to devices on the remote network and the purpose of the DSM is to act as a traffic router and relay point for traffic passed between the local network and the remote network by any participating Host Controller and the Device Controller. The three components work together to automatically accept incoming network traffic from local network devices, process and forward that traffic from the local network to DSM where it is processed and routed to the Device Controller on the remote network, where it is processed and delivered to the target device. In the case of bidirectional data streams, the system has the ability to automatically receive returning packets from the remote device and process them back through the system for delivery to the local device.

It should also be noted that it is possible to encrypt data traffic when it enters the system and decrypt when it leaves the system. If this is done, the system will also provide complete end-to-end data security, protecting traffic from observation while in transit and facilitate data integrity.

In operation, the Host Controller component makes available one or more network interfaces on the local network to originate incoming data streams. Each such interface is configured to use a so-called Virtual IP address (or VIP) as the entry point to the system. A VIP is in fact a real IP address on the local network, there is no restriction on this address other than it is a valid and accessible address on the local network.

A VIP may be thought of as analogous to a virtual memory address in a computer system—a virtual memory address is accessible to local programs being executed by the processor and all attempts to access a virtual address are automatically mapped to a real address in the computer's physical memory. Analogously, all attempts by networked devices to access a VIP address are automatically and transparently translated and passed to the target physical address by the system.

Each such interface can accept incoming network traffic from any network device that has access to that VIP (including, but not limited to for example TCP/IP data streams, individual UDP packets or ICMP control messages). In the case of TCP/IP data streams, to improve performance, the Host Controller may perform the initial three way handshake needed to establish the TCP/IP session before starting to forward traffic to the DSM. In this case, the Device Controller, when it receives the initial data packet for the target device will first successfully complete the three way handshake with the target device before starting to deliver incoming packets. Otherwise, in general, all incoming network traffic is automatically forwarded to the DSM component for processing and routing to the final destination (although it is possible to establish filtering on any VIP, if desired.) This may be done, for example to limit network broadcast packets or ICMP control message packets to the local network, as needed.

The DSM is configured to store a mapping from each VIP to a target networked device. This mapping consists of the incoming VIP and a unique identifier for the source Host Controller, as well as the target IP address of the destination networked device and a unique identifier of the corresponding Device Controller.

Note that because of the use of unique identifiers for each participating Host Controller and Device Controller, it is possible to identify a usable route from each VIP to each target device, even when both devices are using private addresses and/or when there otherwise exists no route to the remote network from the originating network. In fact both devices may be using the same private IP address and the system will still work because the two devices may be distinguished by the corresponding Host Controller and Device Controller components.

Note also that because each target device has its own VIP, there is no need to install any special software or make any configuration changes to the originating device. Applications simply use the VIP address in place of the non-routable target device address the system provides the needed transport mechanism. It is also possible to put VIPs into the Domain Name System (DNS). In this case, a VIP may be changed, or replaced with a routable address, with no need for any further configuration changes on the originating networked device.

It should be noted that neither the Host Controller nor the Device Controller require any special administrative privileges to install or operate on a network, nor is there any need for statically assigned IP addresses for either component. Each may use the Dynamic Host Control Protocol to request needed addresses for itself and assigned VIPs, if desired. The Host Controller will create a virtual network interface for each VIP that it will serve and begin listening for incoming data. When incoming data is detected it will be automatically forwarded to the DSM for processing and delivery to the destination Device Controller.

The Device Controller in turn may come up on the network and begin listening for received data from the DSM encoded in a format that indicates that it is to be delivered to a device to which it has access. The Device Controller need only remove this system information used to deliver the packet to the Device Controller and forward the resulting data packet to the target device. Any return data packets can be automatically forwarded to the DSM for routing back to the appropriate device via the Host Controller.

In practice it is possible to combine more than one of the system components onto a single device. For example, you may package the Host Controller and Device Controller functionality into a single device (which we call a Device Services Controller). Doing so would allow such a device to either originate or terminate a network connection, or even have multiple simultaneous bidirectional network traffic sessions through a single device. You may also elect to place either the Host Controller or Device Controller components and the DSM together on a single device. In such a case you must ensure that a route exists between the combination device and the remaining component, but the system can still arrange to automatically forward to target, non-routable devices.

### BRIEF DESCRIPTION OF THE DRAWINGS

The drawings refer to embodiments of the invention in which:

FIG. 1 illustrates a block diagram of an embodiment of a system to access to and from networked devices in networks protected by firewalls;

FIG. 2a illustrates a block diagram of an embodiment of a system having a Device Services Manager located exterior to a first domain protected by a first firewall and a second domain protected by a second firewall;

FIG. 2b illustrates a block diagram of an embodiment of a system with DSCs each having a Conduit Manager configured to provide a direct communication tunnel to the DSM by authenticating itself to the DSM and establishing an outgoing TCP/IP conduit connection to the DSM and then keeping that connection open for future bi-directional communication on the established TCP/IP conduit connection;

FIG. 3 illustrates a block diagram of an embodiment of a system having a central DSM and local DSCs to access to and from networked devices in networks protected by firewalls;

FIG. 4 illustrates a state diagram of an embodiment of the Conduit Manager in the DSC;

FIG. 5 illustrates a block diagram of an embodiment of an automated centralized administration of a distributed system;

FIG. 6 illustrates a block diagram of an example embodiment of a DSM;

FIG. 7 illustrates a block diagram of an example embodiment of a DSC;

FIG. 8 illustrates a block diagram of an embodiment of the DSM distributing configuration information to the DSCs via an executable boot up file in the DSC;

FIG. 9 illustrates a block diagram of an embodiment of a DSM that automates the allocation of virtual IP addresses;

FIG. 10 illustrates a flow diagram of an embodiment of a network manifold obtaining and reporting virtual IP addresses to the DSM; and

FIG. 11 illustrates a diagram of a DSM creating two or more pools of virtual IP addresses available in the local network.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, networks, etc., in order to provide a thorough understanding of the present invention. It will be apparent, however, to one of ordinary skill in the art that the present invention may be practiced without these specific details. In other instances, well-known components or methods have not been described in detail but rather in a block diagram in order to avoid unnecessarily obscuring the present invention. Further specific numeric references such as first network, may be made. However, the specific numeric reference should not be interpreted as a literal sequential order but rather interpreted that the first network is different than a second network. Thus, the specific details set forth are merely exemplary. The specific details may be varied from and still be contemplated to be within the spirit and scope of the present invention.

In general, the various methods and apparatuses are described to provide a central system to access devices on remote networks using virtual IP addresses. Each DSC (a combination of Host Controller and Device Controller functionality packaged together to simplify deployment and administration of the system) may have a Conduit Manager to create a direct communication tunnel to a DSM. The first DSC resides in a first local network and the second DSC resides in a second local network distinct from the first local network. The DSM resides in a wide area network external to both the first and second DSC. Both the first and second DSC create their own direct communication tunnel to the DSM by periodically establishing an outgoing TCP/IP conduit connection to the DSM, authenticating themselves to the DSM and then keeping that connection open for future bi-directional communication on the outgoing TCP/IP conduit connection. An IP redirector in the DSM receives communication traffic from a first established TCP/IP conduit connection from the first DSC and then routes the communication traffic down a second established TCP/IP conduit connection to the second DSC based on virtual IP address mapping stored in the registry or internal data store of the DSM.

A network access module in the DSM may be configured to create example pairings of 1) each DSC's unique identifier and the virtual IP address of the local network assigned with the DSC, and 2) a unique identifier of a remote DSC and a real, otherwise inaccessible IP address of a network device on a destination network. The DSM stores these pairings in the registry of the DSM.

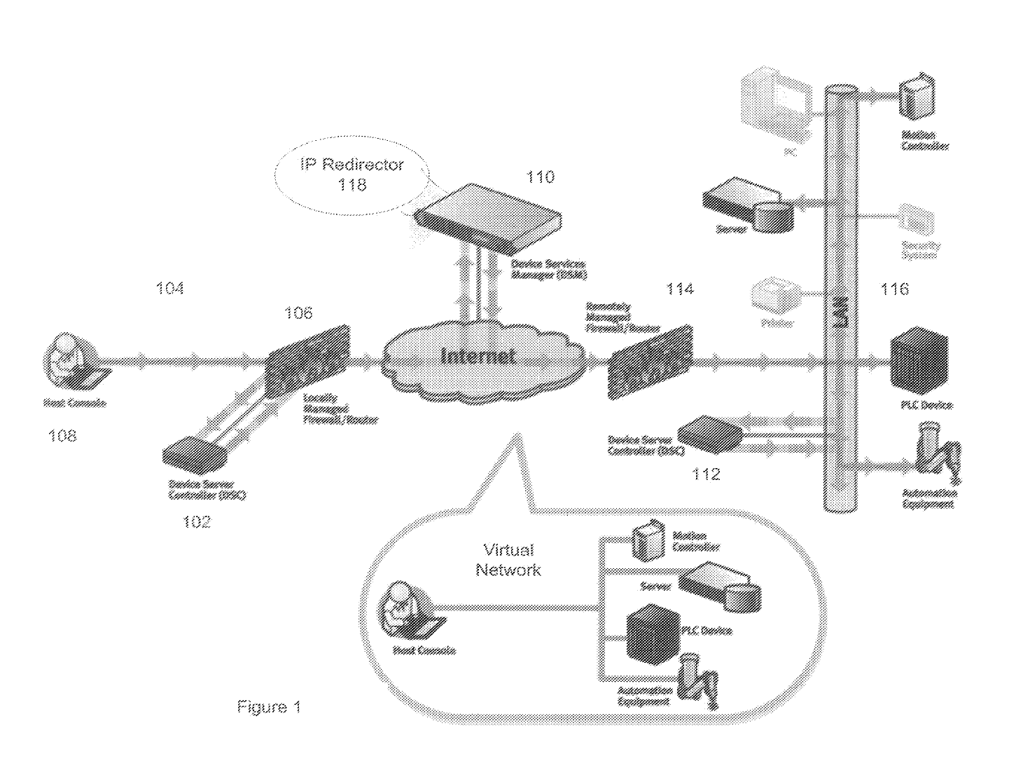

FIG. 1 illustrates a block diagram of an embodiment of a system to access to and from networked devices in networks protected by firewalls.

A first device service controller 102 (DSC) in a first network 104 protected by a first firewall 106. The first network 104 may contain a host console 108 associated with the first DSC 102. The host console 108 controls and manages a subset of equipment in a second network 116 protected by a second firewall 114. The second network 116 is located over the Internet from the first network 104 and the host controller 108. The first device service controller 102 in the first network 104 and a second device service controller 112 in a second network 116 cooperate with a device service manager server (DSM) 110 located on the Internet to provide highly secure remote access to the subset of equipment in the second network 116 through the firewalls 106, 114. The device service manager server 110 has an IP redirector program 118 containing code to perform machine-to-machine communications, via a direct communication tunnel, with each device service controller through the firewalls 106, 114. The subset of equipment in the second network 116 may for example, include a server, a PLC device, a motion controller, automation equipment, a printer, a security system and a personal computer.

In operation, the user from the host console 108 opens a connection to a designated VIP address on a local DSC, i.e. the first DSC 102, operating in Host Controller Mode. This local DSC will accept the connection and hold the connection pending the establishment of a connection through to the target device. This local DSC will then initiate a connection to the controlling DSM 110 (if it is not already established), and the DSM will map the connection to a corresponding managed device IP address. The local DSC sends its identification information to successfully authenticate itself to the DSM 110. The associated DSC responsible for the target device, i.e. the second DSC 112, will periodically open a secure tunnel with the DSM 110 and determine if there is a pending connection (if such a connection is not already established). If there is a pending connection, the DSM 110 will instruct the DSC to initiate a proxy connection to the DSM 110, through which it will pass the traffic for the pending connection. The local DSC behind the firewall holds the direct communication tunnel with the DSM 110 open if there is a pending connection.

The direct communication tunnel between the first DSC 102 and the DSM 110 as well as the direct communication tunnel between the second DSC 112 and DSM 110 combine to allow secure access and management of equipment using addresses which are not accessible from the host console and in a network protected by a firewall while maintaining a network's IT policy and the integrity of the network's firewall. The connection points to the first DSC 102 and the second DSC 112 are not publicly exposed outside their respective networks to devices external to their networks because the DSCs 102, 112 are located behind their respective firewall 106, 114 to increase security of the communications through the direct communication tunnel. When the local DSC successfully authenticates to the DSM 110, the DSC can immediately begin providing secure access to any device on that network which has been assigned a VIP and corresponding route, such as the PLC device, in the network that has been designated as visible to a participating DSC. The designated visible devices have been authorized by the user of the second network 116 to be published.

As discussed, visible associated devices have been authorized by the owner of that domain to be visible/published and may be seen as elements of a collection of networked devices which are made available to the host controller as a single set of “virtual” local devices. The term “virtual device network” (VDN) is used to refer to such collections of devices. In this example, the subset of equipment in the second network is accessible to the Host Console and includes a server, a PLC device, a motion controller, and the automation equipment, while the printer, a security system and a personal computer have not been authorized by the administrator to be visible to the VDN.

In practice, all administration of the system may be carried out by accessing an interface that permits altering the Registry on the DSM, where information about VIPs on each DSC and corresponding routes between VIPs and each non-routable address are stored. The local DSCs may collect information about local devices and forward this information to the DSM, or the information may be entered by the system administrator by hand. Such information can include the DSC's identifier and IP address, and each component's IP address, name, capabilities, protocols supported, etc., within that DSC's network.

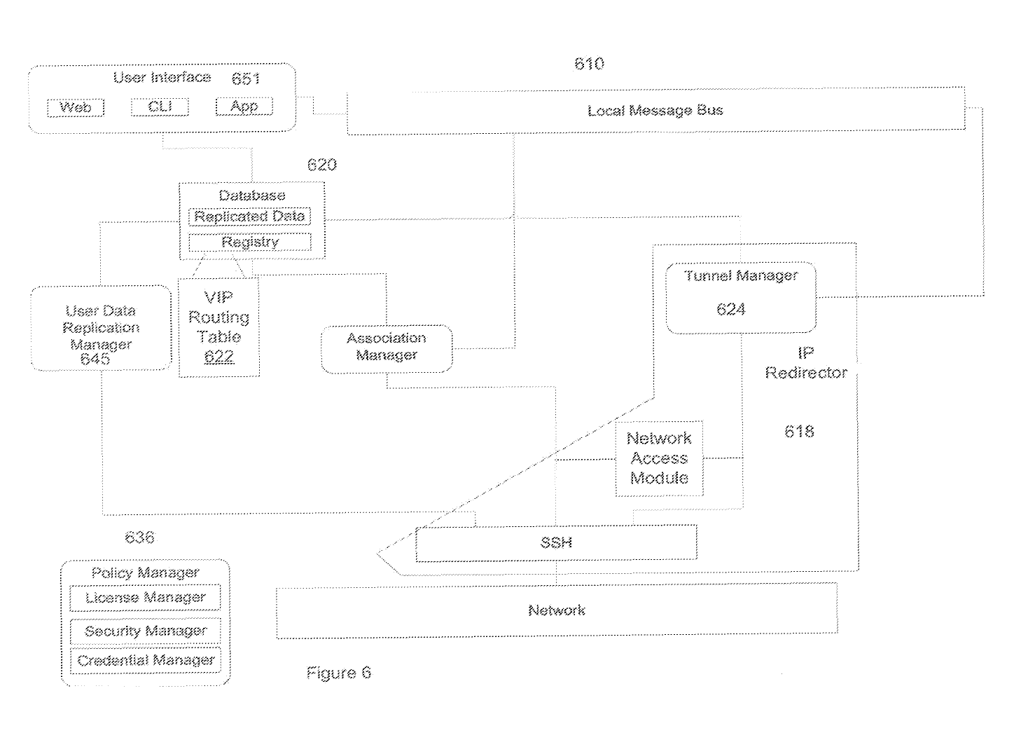

FIG. 6 illustrates a block diagram of an example embodiment of a DSM. The DSM 610 may contain components such as an IP redirector 618 that includes a Tunnel Manager in the DSM 610, a user interface, a database 620 that includes a registry, an association manager, a policy manager, a replication manager, and other similar components.

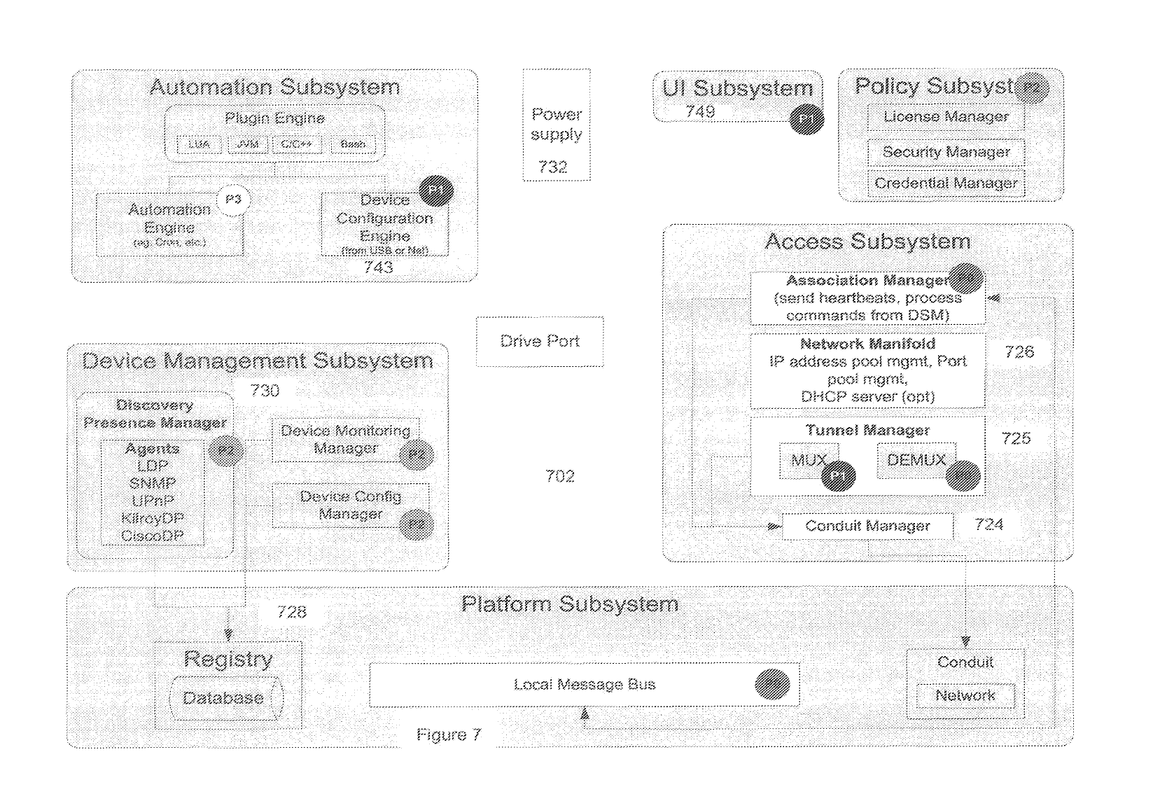

FIG. 7 illustrates a block diagram of an example embodiment of a DSC. The DSC 702 may contain components such as an Access Subsystem that includes the following components: an Association Manager; Conduit Manager 724; a tunnel manager; and a network manifold 726. The DSC may also include a local database 728 that includes a registry, a discovery manager 730, device configuration manager, a device monitoring manager, an automation subsystem including a device configuration engine 743, a user interface, a power supply 732, a drive port 734, and other similar components. Each DSC may have a discovery manager 730 configured to detect and register local devices on the same local network, the Conduit Manager 724 configured to initiate and control the outgoing TCP/IP conduit connection to the DSM 210, and a tunnel manager 725 configured to multiplex and de-multiplex TCP/IP connections to detected and designated visible devices on the second local network.

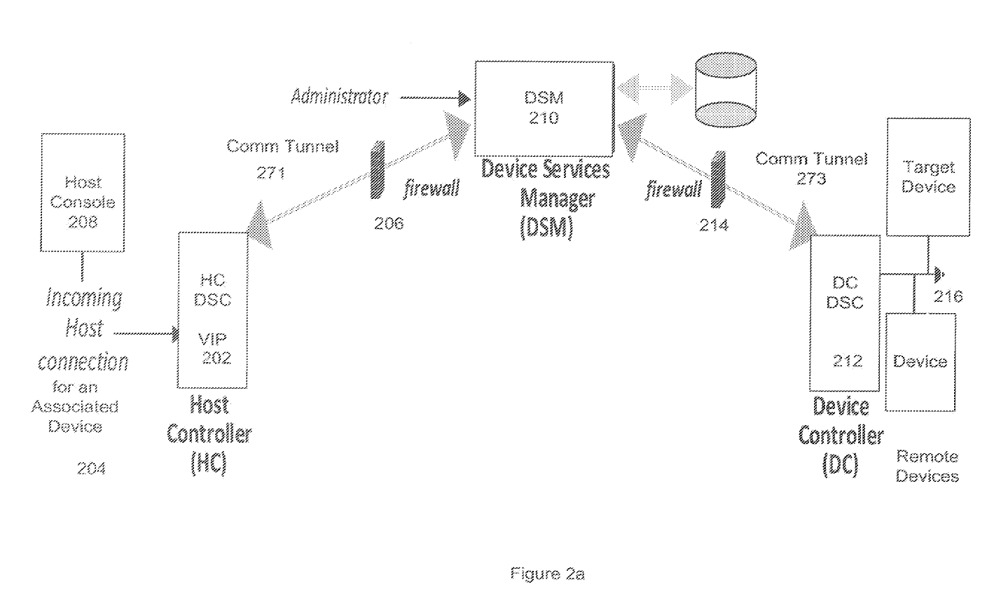

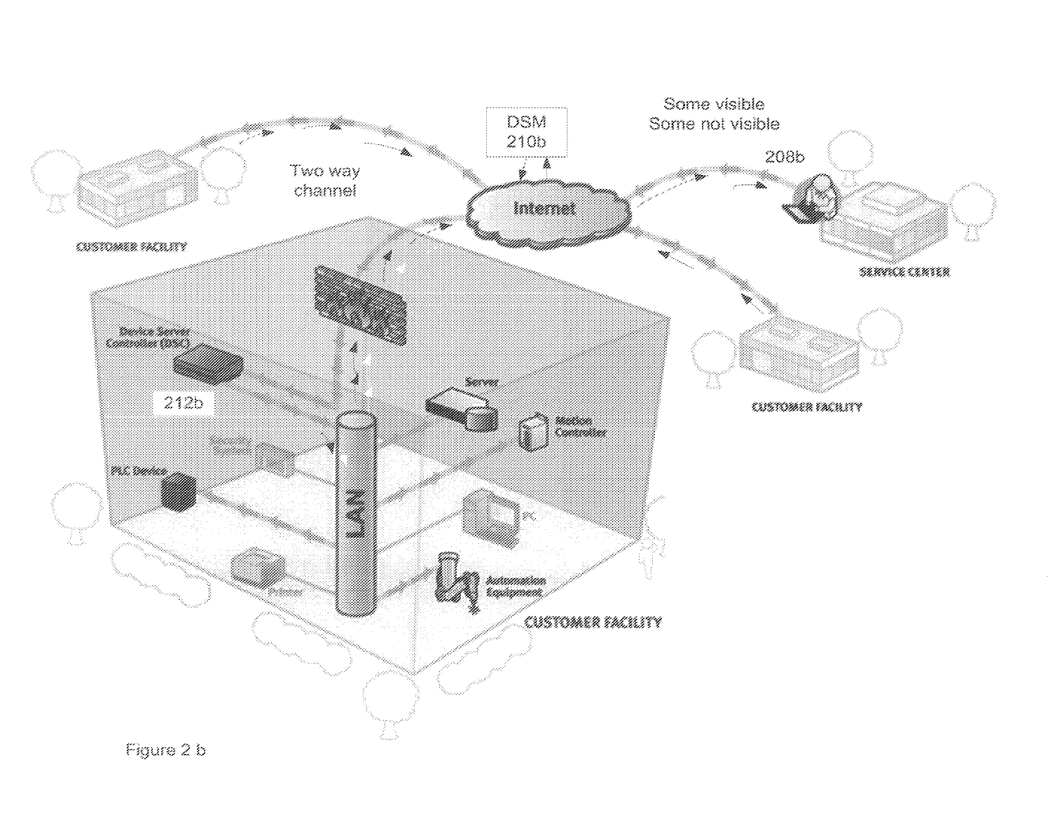

FIG. 2a illustrates a block diagram of an embodiment of system having a device service manager server located exterior to a first domain protected by a first firewall and a second domain protected by a second firewall.

Each DSC 202, 212, is configured with hardware logic and software to act as both 1) a Host Controller (which establishes connections for both itself and its associated devices in the first domain 204 to the DSM 210 located beyond the first firewall 206 and 2) a Device Controller which receives and manages incoming connections from the DSM 210 to individual remote target devices in the second domain 216 protected by the second firewall 214. Note: A domain may be any network separated by a firewall or different subnets. The DSC will be able to proxy connections for both itself and its associated devices to its parent DSM located beyond the local domain. Each DSC may be configured to periodically send an outbound communication to check with the DSM to see if any pending TCP connections are waiting.

In an embodiment, the first DSC 202 and the second DSC 212, each have a Conduit Manager to provide the direct network communication tunnel to the DSM 210 by authenticating itself to the DSM 210 and establishing an outgoing TCP/IP conduit connection to the DSM 210. Both the first and second DSCs 202, 212 establish the outgoing TCP/IP conduit connections to the DSM 210 by periodically authenticating itself to the DSM 210. The DSC keeps that connection open for future bi-directional communication on the outgoing TCP/IP conduit connection. The established and authenticated, bi-directional communication, TCP/IP conduit connection may be known as a direct network communication tunnel or conduit tunnel. The first DSC 202 creates a first outgoing TCP/IP conduit connection 271 and has a first virtual IP address associated with that DSC. The second DSC 212 creates a second outgoing TCP/IP conduit connection 273 and has a second virtual IP address associated with that DSC. The IP redirector of the DSM 210 sends routed packets down a first established TCP/IP conduit connection to the first DSC 202 and sends routed packets down a second established TCP/IP conduit connection to the second DSC 212. The IP redirector of the DSM 210 routes communication traffic for a network component in the first domain 204 behind the first firewall 206 down the first established TCP/IP conduit connection 271 to the first DSC 202. The IP redirector of the DSM 210 also routes communication traffic for a network component in the second domain 216 behind the second firewall 214 down a second established TCP/IP conduit connection 273 to the second DSC 212. Note, because TCP/IP is a bi-directional stream protocol, the DSM 210 can send routed communication traffic down the open communication conduit tunnel and receive traffic from each DSC 202, 212.

The host console 208 and the subset of equipment in the second network form part of the VDN in which the host console 208 controls and manages the subset in second network by the second DSC 212 traversing outbound through a local firewall and/or a customer's NAT routers to access the subset of equipment on the remote network. The host console 208 establishes a single out-bound connection through the first DSC 202 to the DSM 210 controlling the VDN, which allows two-way communications, and then holds that out-bound connection open. The VDN via the DSCs cooperating with the DSM 210 may create dedicated TCP/IP connections between any two points on the Internet.

Overall, after the DSCs 202, 212 and DSM 210 are installed and the DSC discovers and registers all of its associated devices in that local network, then virtual IP addresses may be assigned in the DSM 210 and creation of virtual device network routes can occur.

Steps 1-8 below can be used to achieve automated access to and from networked devices using virtual IP addresses.

In step 1, an initial DSC configuration is loaded into a configuration file of the DSC, such as the first DSC 202, using a secure configuration file via a portable computer readable medium, such as a USB flash drive, eliminating a need for a user interface on the first DSC 202 device. Once power is applied to the first DSC 202, a Conduit Manager of the first DSC 202 establishes the first outgoing TCP/IP conduit connection 271 and then all other needed configuration information is downloaded over the first outgoing TCP/IP conduit connection 271 from the DSM 210 to the first DSC 202.

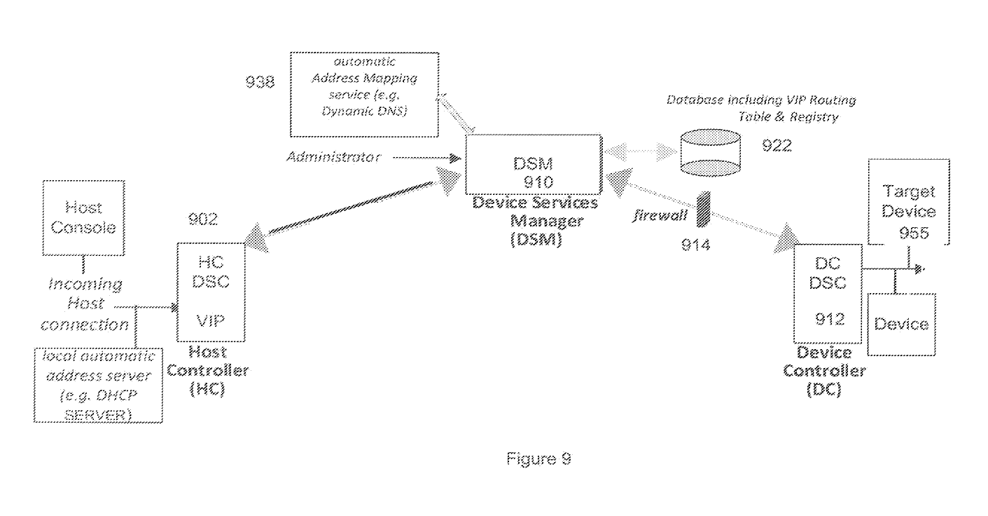

Accordingly, a DSC 202, 212 opens an outgoing tunnel 271, 273 and communicates its presence on the local network to the DSM 210. Each DSC discovers associated devices in the local network and behind the firewall if one exists. For example, see FIG. 9: No firewall in the first network but a firewall in the second network. The local DSC consolidates all of the published information from that network and passes that published information on to the DSM 210.

The published information may be, for example, DSC identification (unique ID, real IP address, name, capabilities, protocols supported, connection end points, connections, host information, etc.)

In step 2, in DSM 210, a virtual device network administrator may manually send a request communication to the newly announced DSC to find out what virtual IP addresses are available in its local network. Alternatively, the DSC may be configured to initially find out what virtual IP addresses are available in its local network and then report those IP addresses to the DSM 210 on its initial set up with the DSM 210 and each time the local virtual IP address information updates. Each DSC may obtain available VIP addresses using a local automatic address server.

In step 3, in DSM 210, the virtual device network administrator may manually specify a virtual IP address (i.e. Host Controller/Local IP pair) and route to a destination device (i.e. corresponding DC/IP pair). In the DSM 210's registry, the DSM 210 creates a pairing of the DSC's unique identifier and the virtual IP address associated with the DSC. The DSM 210 also creates a pairing of the unique identifier of host DSC controller and the real IP address of the host DSC controller, and the unique identifier of DSC on remote network and the real IP address of the target device. The DSM 210 stores these and other similar pairings. The DSM 210 has a VIP Routing Table that stores real IP addresses, virtual IP addresses, routes to devices, all published information of the DSCs and their associated visible network components, connection end points, connection routes, current connections, host information, and similar information and is part of the Registry in the DSM 210 (see FIG. 6 and FIG. 9). The VIP Routing Table allows the DSM 210 to map virtual IP addresses assigned by DSM 210 to real IP addresses behind DSC. The DSM 210 automates the mapping from a virtual IP address to a real IP address, whether or not the real addresses may or may not be NAT′ed. Note in the pairing, the DSM 210 may use the unique ID associated with each DSC, however, the pairing could also use the MAC address or real IP address assigned to that DSC. However, the MAC address or real IP address assigned to that DSC can possibly change in the future and thus require more administration.

See FIG. 9 for more embodiments and details on how virtual IP addresses are allocated.

In step 4, the DSM 210 automatically copies the virtual IP addresses to a local Device Service Controller, such as the first DSC 202, associated with a host console, i.e. a Host Controller, which begins listening for incoming connections from the host console. The DSM 210 can repeat this process of assigning virtual IP addresses with the second DSC 212. In an embodiment, a virtual interface may be implemented on each DSC to allow multiple connections to be listened for. The virtual interface sets up a virtual IP address for each link and can thus handle TCP/IP connections to any arbitrary port on any target device.

In step 5, to begin communications, the host console 208 connects to the appropriate “virtual IP” (VIP) address associated with a route configured by the virtual Device network administrator. This VIP connection is automatically routed through to the first DSC 202 to be delivered to the correct device. Thus, the local DSC in multiplexer mode transparently redirects communication traffic, such as packets from the host console 208, to the DSM 210. Accordingly, the local Device Service Controller associated with a host console 208 accepts incoming traffic packets from the host console on a VIP address.

Overall, the first DSC 202 adds the DSC-VIP address-pairing information into a header of an incoming packet and then merely forwards the packet to the DSM 210, which will make the routing decisions based on mapping of the real IP address of the target device to the virtual IP address associated with DSC responsible for that target device. Thus, the tunnel manager program in the first DSC 202 adds onto a header of the communication traffic, i.e. packet information that includes 1) that the communication traffic is coming from the first DSC 202, such as its unique ID, and 2) identifying information on the originating device in the first local network by including both the source device and port originally sending the communication traffic, such as its real IP address, and then forwards the communication traffic to the DSM 210 for routing over the Internet.

Note, the incoming connection from the associated devices can include both stream traffic (e.g. TCP/IP) and packet traffic (e.g. UDP) oriented network connections. The TCP packet header information in general identifies both the source port originally sending the data and the target destination port receiving the packet.

Thus, the host console initiating the communication traffic to a remote target device in the second network connects to the first DSC 202 on the first local LAN, in which a tunnel manager program in the first DSC 202 multiplexes traffic onto the first outgoing TCP/IP conduit connection 271 and forwards the communication traffic to the DSM 210.

In step 6, the DSM 210 maps the first outgoing TCP/IP conduit connection to a corresponding virtual IP address and port associated with the second DSC 212. The IP redirector of the DSM 210 determines an intended target device address to a target device in a subset of equipment in the second network. The IP redirector of the DSM 210 determines the information associated with the second DSC 212 in the second network by consulting a routing table that stores at least real IP addresses, virtual IP addresses, and routes to the subset of equipment. The DSM 210 has a virtual IP address Routing Table in the DSM 210's registry that stores at least real IP addresses of each DSC and the network devices on that local area network, which are designated as visible by a user of the local area network, and the virtual IP addresses, and routes to devices, where the DSM 210 uses the information in the virtual IP address Routing Table to map a virtual IP address assigned by the DSM 210 to a real IP address associated with a given DSC to establish the route. The DSM 210 determines an appropriate VIP route by referencing the VIP Routing Table, and then forwards each packet to appropriate second Device Controller for delivery to target device. The DSM 210 determines the appropriate VIP route by referencing the VIP Routing Table and seeing that the end target device's real IP address is associated with a given DSC unique ID. The VIP Routing Table also has DSC unique ID associated with a given virtual IP address, and then forwards each packet to appropriate second Device Controller for delivery to the target device in the second network. Thus, the DSM 210 router looks up an end target device's address and sees what DSC is responsible for that end target device and then sends the traffic to the virtual IP address assigned to the DSC that is responsible for that end device.

Overall, the DSM 210 stores, correlates and maps for each DSC, all DSC and its associated devices' published information, route information, available virtual IP address information, as well as other similar information. Thus, the DSM 210 performs port mapping and TCP relay between a DCS in multiplexer mode and a DSC on the other side of the network and firewall in de-multiplexer mode.

Each DSC also has a tunnel manager that in multiplexer mode maps all associated network devices in the first local network to domain names.

In step 7, the second DSC in de-multiplexer mode accepts tunnel request from the DSM 210 through the second outgoing TCP/IP conduit connection established with that DSM 210 and forwards the traffic onto associated devices. Accordingly, the second DSC periodically calls the DSM 210 to see if any traffic is pending for the associated devices in the network hosting the second Device Controller. The second DSC has a tunnel manager to de-multiplex the traffic received on the outgoing communication tunnel with the DSM 210, reads the DSC-VIP pairing information inserted into the header, and then delivers the traffic, such as packets, to the target end device. The second DSC 212 receives communication traffic on the first virtual IP address and routes that communication traffic onto a destination target device also connected to the second local network that the second DSC 212 is part of.

In step 8, the target end device, via routing in the second DSC, returns packets back via the same path to the sender. Both the first and the second DSC 212 have a Conduit Manager to create the direct communication tunnel to the DSM 210. Each DSC creates its direct communication tunnel to the DSM 210 by periodically authenticating itself to the DSM 210 and establishing an outgoing TCP/IP conduit connection to the DSM 210 and then keeps that connection open for future bi-directional communication on the outgoing TCP/IP conduit connection. The IP redirector receives the packets from a first established TCP/IP conduit connection from the first DSC 202 and then routes the packets down a second established TCP/IP conduit connection to the second DSC 212 based on VIP address mapping occurring in the registry of the DSM 210.

FIG. 9 illustrates a block diagram of an embodiment of a DSM that automates the allocation of virtual IP addresses. The DSM 910 has a network access module that includes a network access manager and a tunnel manager, configured to cooperate with two or more device service controllers (DSCs) and serve as a central management station for allocating and assigning virtual IP addresses to network devices to proxy communications for the networked devices on a local area network where each DSC resides 902, 912. The DSM 910 is located exterior from the network devices on the LAN where the communications associated with the VIP addresses are being routed to. Thus, the DSM 910 automates the configuration and allocation of these virtual IP addresses from the central DSM 910, so the user does not need to do anything at the host end to make them work. The DSM 910 assigns virtual IP addresses to a given DSC and establishes a route from the assigned virtual IP address to a destination network device based on corresponding DSC and network device information stored in the DSM's registry 922. The networked devices may be located behind a firewall, such as a local firewall 914, on a local area network relative to a location of the DSM 910 on the wide area network.

On DSM 910, the VDN administrator may manually specify a virtual IP address pair (i.e. Host Controller DSC ID and Local virtual IP address assigned) and route to destination device (i.e. corresponding Device Controller DSC ID and Local virtual IP address assigned pair). Alternatively, the DSC may find out what virtual IP addresses are available in its local network and then report those IP addresses to the DSM 910. The network access module in the DSM 910 creates a pairing of 1) each DSC's unique identifier (ID) and the virtual IP address of the local network associated with the DSC. The network access module in the DSM 910 also creates a pairing of 2) the unique identifier of host DSC controller and the real IP address of the host console network device associated with the unique identifier of DSC on the first local area network, as well as a pairing of 3) the real IP address of the destination network device and the unique identifier of the destination DSC on the second local area network. The network access module in the DSM 910 then stores these pairings in the VIP routing table in the DSM 910 in the DSM's registry 922. The pairing could also be a pairing of a virtual IP address of the local network to the unique identifier of the DSC for that local network, other pairings of network devices on the local networks and a virtual IP address associated with that local network are also possible. This routing information is added on top of the existing packet routing information, in the header portion of the packet.

The DSM 910 may integrate with an automatic address mapping service, such as a Domain Name System 938, since applications do not need to change their target ports or be reconfigured to use a different port. All an administrator needs to do is set up a domain name pointing to the virtual IP address (VIP) and the user application remains completely unchanged.

The VIP Routing Table 922 may further store the VIP addresses, the VIP address to unique ID pairings, routes to devices, and similar information. The virtual IP address Routing Table 922 may also store at least 1) the real IP addresses of each DSC and the network devices on the local area network designated as visible by a user of the local area network, which are registered with the DSC, 2) the virtual IP addresses of the DSC and the network devices registered with the DSC, 3) connection routes to devices, 4) all published information of the DSCs and their associated visible network components, and 5) connection end points, current connections, host information, and similar information. The virtual IP address Routing Table 922 makes up part of the Registry in the DSM 910. With this stored information, the DSM-DSC system then can map a virtual IP address assigned by the DSM 910 to a real IP address associated with or behind each DSC to establish the route between an initiating network device and a destination device. Overall, the DSM 910 automates the mapping from a virtual IP address to a real IP address, whether or not the real addresses may or may not be NAT'ed. Note: DSC devices are configured to register both themselves and any associated network devices with the DSM Registry 922 and periodically update that information. Also, the local DSC 912 receives the traffic from the DSM 910 and then actually routes the traffic to the real IP address associated with the destination target device such as a first network device 953.

The DSC's unique identifier for pairing purposes in the DSM 910 may be the unique ID hard coded into each DSC, the MAC address assigned to that DSC, or the real IP address assigned to that DSC. However, the MAC address or real IP address assigned to that DSC can possibly change in the future and thus require more administration than the unique ID.

The network access module of the DSM 910 has code scripted to instruct the host DSC Controller 902 to find out what virtual IP addresses are available in its local network and then report those VIP addresses to an association manager in the DSM 910. The DSC 902 can obtain the VIP addresses using a local automatic address server 940 (e.g. DHCP), and then copies the VIP addresses back to the association manager in the DSM 910.

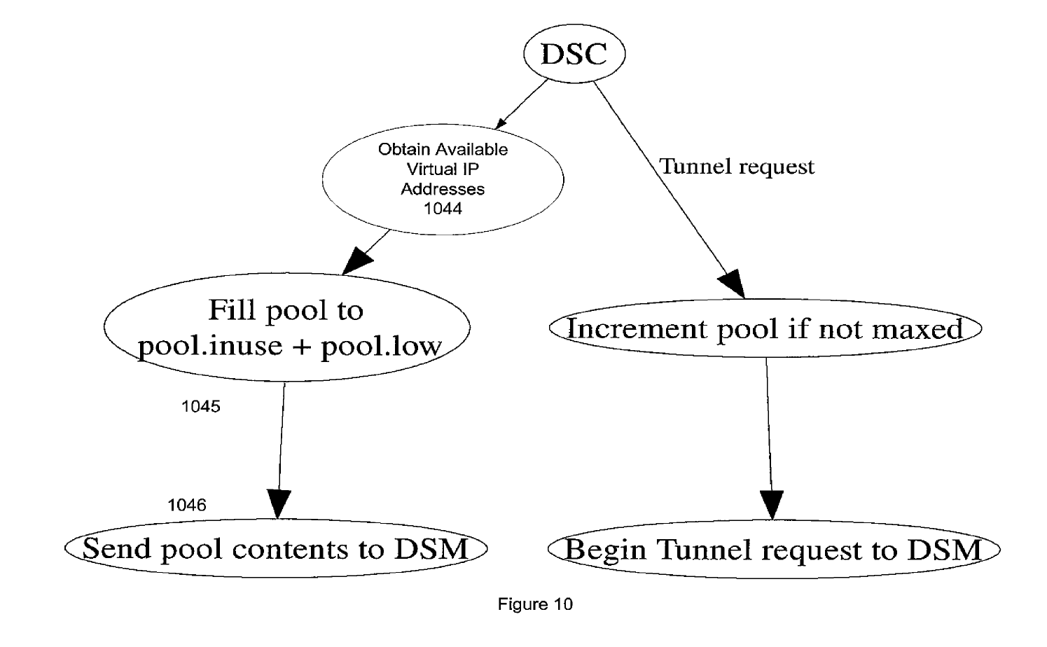

FIG. 10 illustrates a flow diagram of an embodiment of a network manifold in a DSC obtaining and reporting virtual IP addresses to the DSM.

Referring to FIGS. 9 and 10 in operation in block 1044, the DSM automatically instructs the network manifold of the Host DSC Controller 902 to obtain a local VIP address, e.g. using DHCP, when the DSC initially communicates with the DSM and then periodically as follows. The network manifold of the DSC 902 then uses the local automatic address server 940 to pick up a VIP address on 1) each connection occurrence basis or, 2) for efficiency in block 1045, picks up VIP addresses from a pool of VIP address pre-identified as available VIPs in this local LAN by DSC 902 to DSM 910. In block 1046, the network manifold of the DSC can obtain the VIP addresses using a local automatic address server 940 (e.g. DHCP), and then copies the VIP addresses back to DSM 910. The DSM 910 automates the configuration of these virtual IP addresses from the central DSM 910, so the user does not need to do anything at the host end to make them work. The network access module then updates routing information in the VIP Routing Table 922 to be able to correlate/map real IP addresses with assigned VIP addresses and store that association in the DSM registry 922 as well as in, potentially, a domain name server 938 to associate a domain name to a VIP address.

In an embodiment, the association is stored permanently in the VIP Routing Table 922. In an embodiment, the association pairing is temporarily stored in the VIP Routing Table 922 while the connection is active and then placed in a queue of stored pairs, such as 100 stored pairs, until replaced by new active connection needing a pairing and is overwritten on a least frequently used basis.

As discussed, the Host DSC 902 may query the DSM 910, or even directly query the DNS 938. The Host DSC 902 may query the DNS 938 for the correct virtual IP address, or obtain this by querying the VIP Routing Table 922. The Host DSC 902 connects to the new VIP address assigned to DSC. Upon receiving a query, the network access manager in the DSM 910 may establish a route from a domain name to a remote target device via address the automatic mapping service 938 (i.e. Dynamic DNS). The automatic mapping server 938 sets up a domain name pointing to the virtual IP address and maps the traffic from the originating network device (i.e. Host Controller DSC ID and Local virtual IP address assigned pair) to the destination device (i.e. corresponding Device Controller DSC ID and Local virtual IP address assigned pair). Thus, the DSM 910 maps the specified pairing of the virtual IP address assigned to first DSC 902 and its unique ID to the pairing of the IP address assigned to a second DSC 912 and its unique associated with the domain name. The network access manager in the DSM 910 cooperates with a domain name server to optionally update one or more address records in the DNS 938 to allow automatic domain name-to-IP address resolution. In an embodiment, a domain name may be an alphanumeric name that is mapped to a numeric IP address in order to identify a computing device on the Internet. Thus, the originating network device may merely type in a domain name for traffic headed to a destination device.

The DNS 938 is connected and operated by the DSM 910 and may create a virtual IP address for each active connection. Rather than forwarding individual ports from multiple devices to a single public IP address, the network access module in the DSM 910 cooperating with the network manifold in each DSC 902, 912 sets up a virtual IP address for each link, and each DSC, and can thus handle TCP/IP connections to any arbitrary port on any target device. This solution can be easily integrated into the Domain Name System, since applications do not need to change their target ports or be reconfigured to use a different port. All you need to do is set up a domain name pointing to the virtual IP address and the user application remains completely unchanged.

Operationally, the DNS Server 938 merely needs to allocate a virtual IP address when a DNS query occurs. Each DSC 902 912 pre-allocates a pool of VIP addresses available in its LAN, then sends this pool of VIP addresses to the DSM 910. The DSM 910 is then free to assign and use VIP address entries from the pool as needed. The only information the DSC needs is whether to allocate or reclaim VIPs from the pool.

In order to prevent obvious DoS attacks, the DSM 910 maintains two pools for assigning virtual IP addresses. A smaller pool of VIP addresses is used for requests from unknown public IP addresses and a larger pool of VIP addresses is used for requests from known IP addresses registered with the DSC. Once a connection is established, the public IP from which that connection arrives is placed in an automatic white-list pool, which is then allowed to have longer timeouts.

The entries in the white-list may also have exponential decay timers to automatically remove them from the white-list pool after the connection terminates.

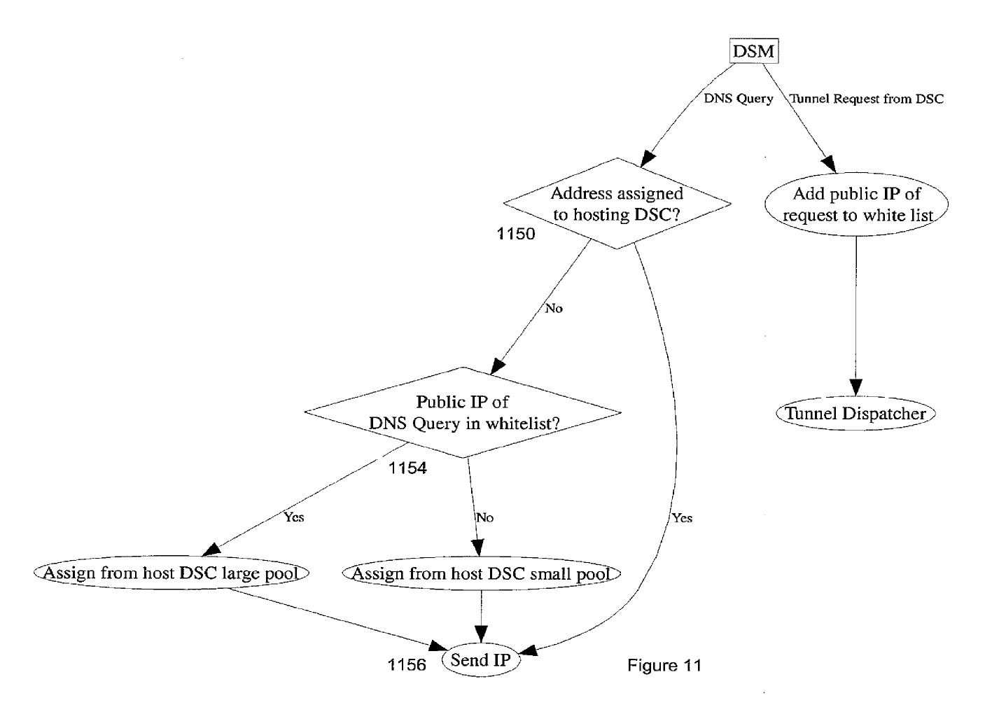

FIG. 11 illustrates a diagram of a DSM creating two or more pools of virtual IP addresses available in the local network.

Referring to FIG. 11, in operation in block 1150, the network access module in the DSM, on a DNS query, checks to see if a virtual IP address is assigned to the hosting DSC.

If yes, a virtual IP address is currently assigned to the hosting DSC the network access module sends the virtual IP address to the hosting DSC.

If no, a virtual IP address is not currently assigned to the hosting DSC, in block 1154, the network access module checks whether the query comes from a public IP address or the query is from a DNS query whitelist.

If yes, the query does comes from a registered public IP address or from the white list, then the network access module assigns a virtual IP address from the large pool of available virtual IP addresses available for the host DSC.

If no, the query does not comes from a known public IP address or from the whitelist, then the network access module assigns a virtual IP address from the small pool of available virtual IP addresses available for the host DSC.

Now the virtual IP address is assigned to the hosting DSC.

In block 1156, the network access module of the DSM sends virtual IP address in response to the query.

Referring to FIG. 9, the network access module in the DSM 910 on a tunnel request from a DSC adds the public IP address of the request to a whitelist and then sends it to the tunnel dispatcher.

Note that there is no requirement for network administrator intervention on the intervening firewall or NAT device, nor any requirement for any configuration changes to the host device to use this mode, but the network administrator should create a sub domain for the desired DNS domain (i.e. local network) and either delegate that sub domain to the DSM 910 or allow the DSM 910 to provide dynamic DNS updates.

Referring to FIG. 7, as discussed, each DSC 702 has a network manifold 726 configured to manage and maintain the one or more pools of IP addresses via DHCP, port management, and a DHCP server. The network access module 726 in the DSC 702 may consist of the following components: a DHCP Server, a virtual IP Pool Manager, to maintain the collection of virtual IP addresses, and a Port Pool Manager to maintain a pool of ports.

The network manifold 726 in the DSC 702 is responsible for maintaining a pool of virtual IP addresses for use by the DSM 910 when mapping an IP address to a domain name.

The network access module 726 in the DSC 702 keeps several values for its operation:

pool.max specifies the maximum number of IP addresses the DSC 702 will reserve at one time (excluding itself);

pool.lowmark specifies the number of IP addresses to always keep in reserve (unless pool.max is reached); and

pool.inuse the number of IP addresses currently in-use.

The network access module 726 in the DSC 702 communicates with the network access module in the DSM to gain the pool in-use amount. In addition, the network access module 726 in the DSC 702 should be able to query the DSM for the usage of each in-use IP address for expiration purposes.

The DSC 702 needs no additional knowledge of the destination. In fact, the DSC 702 has no knowledge of the final destination of the tunnel.

The tunnel manager 725 in the DSC 702 communicates with the network manifold 726 as well as other internal processes both in multiplexer (MUX) and demultiplexer (DEMUX) mode and directs tunnel traffic. The MUX mode allows associated network devices to a DSC to communicate with associated network devices of another DSC in other domains. The DEMUX mode redirects tunneled traffic from the DSM to associated network devices in the local domain. MUX mode may have two associated programs. The Port MUX tunnels local ports either TCP/UDP to the DSM 910. The virtual IP MUX tunnels traffic to virtual IP addresses to the DSM 910.

The Tunnel MUX manager 725 accepts connections (TCP/UDP) on a DSC from the local LAN. By using Netfilter/IP Tables, all virtual interfaces on a DSC can be redirected to a single Tunnel MUX manager daemon.

The MUX Manager can then query the Netfilter interface for the intended destination to determine the virtual IP address. Upon connection to the DSM Tunnel Manager, the MUX Manager can send the virtual Destination IP, virtual Destination Port number, and DNA ID of the local DSC.

Based on this information, the DSM can determine where the packet is actually intended to go and then proxy the connection.

The MUX TCP Tunnel Handler sends some initial header information to the DSM. It then performs a similar function to tcp_relay3.

The Tunnel DEMUX Manager's task is very simple. Upon receiving a connection and doing some authentication, it reads an initial header to determine the packet type and destination. The Tunnel DEMUX Manager then spawns either the tcp_relay agent or the udp_relay agent to perform the actual relay task.

In this way, the DSM 910 serves as the proxy access point for multiple associated devices of each DSC operating behind corporate firewalls and customer NAT routers.

In an embodiment, the DSM assigns the virtual IP address to the local DSC by either a DHCP address configuration or from a static pool of virtual IP addresses available to the first DSC. When the local DSC initiates the first TCP/IP conduit connection by querying a designated DNS name for the end target device. The virtual IP address returned will have been supplied by the DSM from the pool of local virtual IP addresses available to the host DSC. When the host device attempts ARP address resolution, the DSC will respond and begin forwarding traffic for this connection to the DSM, which will then forward this traffic to the appropriate device as for DSC Port Forwarding Mode.

The tunnel manager 725 is configured for the DSC 202 to be able to initiate a TCP or UDP connection to an end target device in another local network protected by an intervening firewall and without knowing the real IP address of the end target device.

Referring to FIG. 6, a graphic user interface 651 of the DSM 610 is also configured for the DSM administrator to specify individual device associations, which are defined as a pairing of an existing device configuration with a specific discovered DSC device. Once a device has been associated in the DSM's registry 620, the DSM 610 may apply appropriate configuration changes and shall begin forwarding proxy connections to the DSC for network equipment as per a preset set of Access Rules maintained in the IP redirector module 618 in the DSM 610.

As detected DSCs are found and registered, an appropriate icon may appear in the Device Monitoring Service view of the graphic user interface 651. The user may then associate each such registered device with a previously created configured record. Once that is done, additional device settings (including Discovery search records) can be automatically downloaded to the DSC device. Based upon these settings, the DSC will then begin discovering additional network devices and passing traffic.

The User Data Replication Manager 645 in the DSM 610 provides a mechanism for data to be replicated from a DSC to a DSM. The User Data Replication Manager 645 in the DSM 610 generates a local copy of the device configuration file including the configuration record for that DSC. The DSC uses the secured communications channel implemented in SSH to fetch the local copy of the device configuration file from the central registry 620, and then the DSC updates its locally stored copy of the device configuration file. Thus, a shadow configuration registry is maintained on the remotely managed DSC device. The DSC then signals to DSM 610 that the update is complete and the DSM 610 updates the DSC's status of remote configuration in the Central Registry 620 of the DSM 610.

FIG. 2b illustrates a block diagram of an embodiment of a system with DSCs each having a Conduit Manager configured to provide a direct communication tunnel to the DSM by authenticating itself to the DSM and establishing an outgoing TCP/IP conduit connection to the DSM and then keeping that connection open for future bi-directional communication on the established TCP/IP conduit connection. A host console 208b connects to a remote DSC 212b via a local DSC and the DSM 210b. The local and the remote DSC 212b can both hold open a direct communication tunnel between themselves and the DSM 210b for bi-directional communications. The direct TCP communication tunnel is a two-way TCP/1P conduit connection/TCP session that is held opened to the DSM 210b. The traffic on the incoming connection is then relayed through that session. The Conduit Manager in the remote DSC 212b may use a certificate-based SSH (Secure Shell) encryption protocol to ensure secure, end-to-end communication between the host console 208b and the destination target device, such as a Motion Controller, via the direct TCP communication tunnel. After the traffic has been communicated, then the TCP session may then be closed. Thus, the direct TCP communication tunnel may be implemented via SSH.

In an embodiment, the direct TCP communication tunnel can also be a simple TCP port forwarder. The program is just listening to a local TCP port and all the received data will get sent to a remote host. The direct TCP communication tunnel allows the user to bypass a firewall that does not allow a remote device to make inbound TCP/IP connections to your server.

The remote DSC is also de-multiplexing the traffic from the direct communication tunnel to the network components on its associated local area network by decoding the header on the traffic and forwarding that traffic onto the target network component. The TCP packet header information in general identifies both the source port originally sending the data and the target destination port receiving the packet.

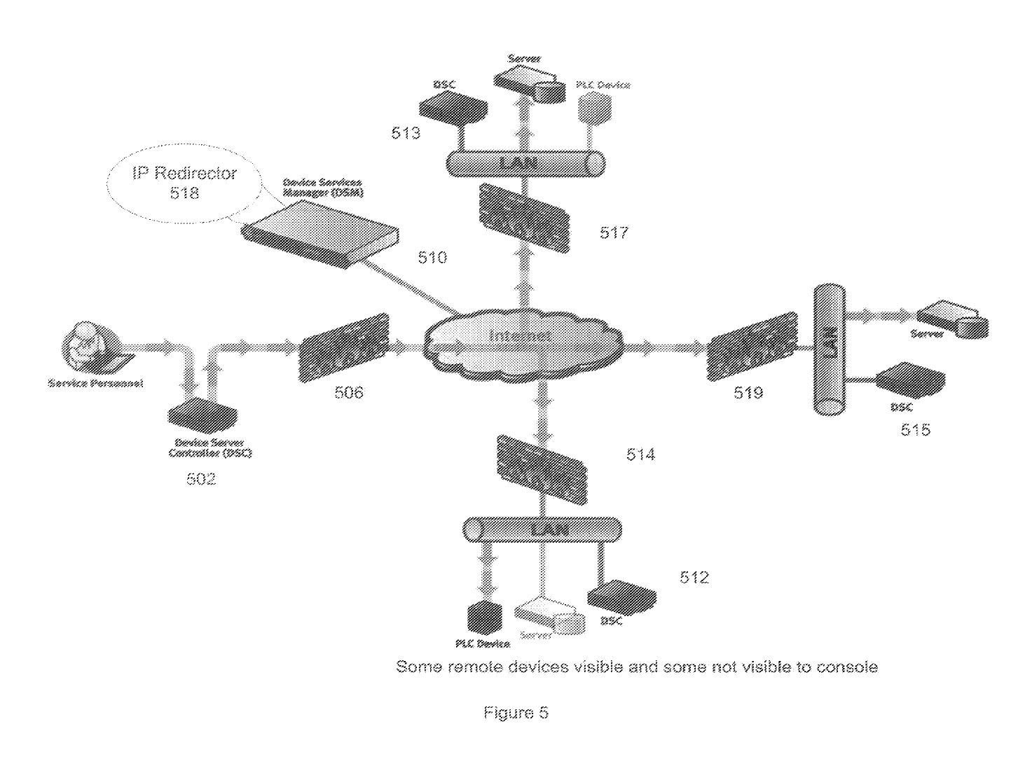

FIG. 5 illustrates a block diagram of an embodiment of an automated centralized administration of a distributed system.

The heart of the system is the DSM 510. The Device Services Manager manages a collection of DSCs 502, 512, 513, and 515. The DSM 510 may have an IP redirector module 518 configured to cooperate with the two or more DSCs 502, 512, 513, 515 that are behind a firewall, such as firewalls 506, 514, 517, and 519, on a wide area network relative to a location of the DSM 510 on the wide area network. The DSM 510 serves as a central management station for automatic distribution of configuration information to the DSCs 502, 512, 513, and 515. An executable boot up file uploaded via a drive port in that DSC is scripted to gather configuration information for that DSC and network devices on the same network as that DSC and without a prompt by the DSM 510 then sends an initial configuration file to the DSM 510. The DSM 510 makes a master copy of the device configuration file in the DSM's registry for that DSC.

Each DSC 502, 512, 513, 515 and the DSM 510 work in concert to provide end-to-end access between associated devices in different Domains. The DSM 510 serves as a proxy connection point for participating DSCs 502, 512, 513, 515. The DSM 110 is a dedicated appliance that relays connections between user hosts and destination devices.

Individual DSC 502, 512, 513, 515 serve as a low-cost point of presence on participating LANs. Each DSC 502, 512, 513, 515 is capable of acting simultaneously as both a Host Controller (which originates connections from host systems) and a Device Controller (which receives and manages incoming connections to individual remote devices). Each DSC 502, 512, 513, 515 is configured to proxy connections for both itself and its associated network devices to its parent DSM 510 located beyond the local LAN.

To the remote network, a newly installed DSC functions like a newly installed computer. To access devices on a remote network, the DSC just needs to establish a single out-bound connection to the DSM controlling the VDN. The outbound connection is a conduit communication link between the DSC acting as a Host Controller and the DSM. Once this connection is established, all system configurations, commands and network traffic can pass through the encrypted channel. When the DSC successfully authenticates to the DSM, it can immediately begin providing secure access to individual pieces of pre-authorized equipment.

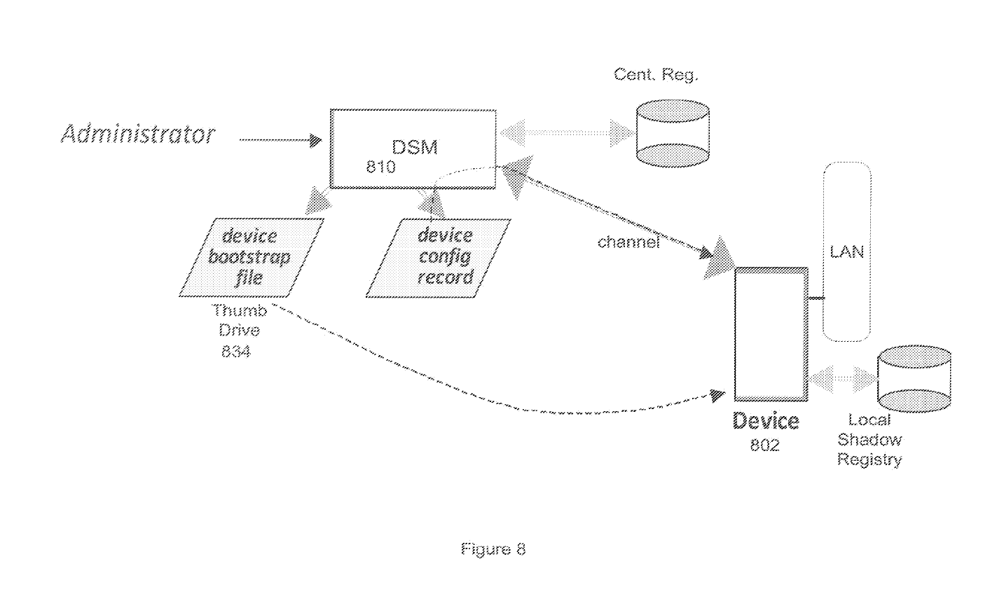

FIG. 8 illustrates a block diagram of an embodiment of the DSM distributing configuration information to the DSCs, such as a first DSC 802, via an executable boot up file uploaded via a drive port 834 in the DSC 810. An administrator of the DSM 810 creates a boot up file and embeds a copy of this executable boot up file on a thumb drive. The thumb drive loaded with the executable boot up file accompanies and is shipped with the DSC device 802. The executable boot up file in the DSC 802 is scripted with code to at least 1) determine a unique ID of that individual DSC device, 2) determine the DSC's current IP address, 3) supply the DSM's IP address on the wide area network, and 4) activate code to initiate communications with the DSM 810.

The DSC device 802 uploads the boot up file from the thumb drive via the drive port 834, uses the contents of the boot up file to automatically create the secure communication channel via SSH between the DSC 802 and the DSM 810 and connects to the DSM 810 at its IP address on the WAN. The DSC 802 then authenticates itself to the DSM 810 via the unique ID, device MAC address, and/or potentially associated DNS entry. The DSM 810 then looks up the authenticating information in a reference table maintained in the DSM 810.

Referring to FIG. 7, as discussed, the device configuration engine 743 in the DSC 702 without a prompt by the DSM then sends an initial configuration file with at least the unique ID of that individual DSC device and the DSC's current IP address information via a secure communication channel, such as via a secure protocol, an encrypted email, or similar method, to the DSM (with individual devices differentiated by device ID, device MAC address and/or potentially associated DNS entry).

Referring to FIG. 6, the DSM IP redirector module 618 receives this configuration information. The DSM 610 has a user data replication manager module 645 to create a device configuration/replication file with this configuration information and additional information and to make a master copy of the device configuration file in the DSM's registry 620. The user data replication manager module 645 then distributes this configuration information back out to the appropriate DSCs in response to the DSC's registering with the DSM 610 or in response to a given DSC performing a system reset. Note the DSM 610 may also send updates of firmware, software patches, etc. in response to the boot up call.

Referring to FIG. 7, the DSC 702 may be a standalone device deployed in an existing network. The deployment consists of merely physically plugging in the power to a power connection and power supply circuit of the DSC, plugging in the Ethernet network connection, and inserting the supplied thumb drive into a drive port 734 (i.e. USB flash drive into USB port). That is it! Thus, the DSC 702 is a standalone device that connects up to the existing network without needing client software to be installed on another host device in that existing network, and no network configuration settings are required from an end-user to properly install the DSC onto the existing network. Therefore, avoiding the problem that many enterprise IT departments do not allow unauthorized third party applications to be installed onto their systems. The DSC 702 then resides on the existing network and mediates communication onto that LAN. No networking knowledge is necessary and access to this remote device is automatically configured. No end-user configuration or software installation is required to properly install the DSC onto the existing network.

An auto discovery presence manager program 730 resident in each DSC 702 finds networked equipment on the existing LAN and establishes an instant point of presence on that local network. The discovery presence manager program 730 discovers associated devices on the network by using a polling technique. The discovery presence manager program 730 has a Graphical User Interface (GUI) 749 to ask a user of a network whether each discovered piece of network equipment protected by the firewall should be visible for remote access by at least the DSM. The DSC device 702 then collects and sends out the initial configuration file with the designated visible network device information to the central management DSM via the secure channel, which the DSM automatically registers both the local DSC and any associated network devices in the DSM-hosted Identity Registry. This information can then be made available via dynamic DNS, LDAP and DHCP, as well as associated web-based directory service application interfaces. In an embodiment, the Auto Discovery service 730 waits to discover network equipment on the existing LAN until the DSM sends back a copy of the master configuration file as well as any firmware and software updates.

The graphic user interface 749 is configured for the DSM administrator to configure Automated Device Discovery for each associated DSC. Multiple individual scan records may be created which specify either SNMPv1, SNMPv2 or another protocol as the search mechanism. When Automated Device Discovery is activated, scan records are copied to the appropriate DSC, which shall use them to initiate periodic scans of their local LAN for attached network devices.

When a device is discovered, the DSC shall create a Discovery record, which shall include as a minimum, the IP address of the discovered device, the discovery protocol used to locate the discovered network device, and the identifier of the discovering DSC. The resulting Discovery records shall be replicated back to the DSM for use by the DSM's Association, Configuration and Monitoring Service components. Each such Discovery record shall be assigned a unique ID, which shall allow the administrator to disambiguate references to individual configurations and discovered devices. The DSM then sends back a local copy for the DSC to store in its registry 728.

Thus, each DSC 702 of the two or more DSCs serves as a local registration authority, accepting registration requests from associated network devices on the existing local LAN, as well as polling for associated network devices on the local LAN. The DSC 702 will maintain a registry 728 of associated devices and will be able to automatically register both themselves and associated devices with its parent DSM registry. Each DSC 702 feeds this data to the parent DSM. Each DSC 702 participates in device discovery and directory service by registering associated devices discovered by using polling techniques.

In an alternate embodiment, the DSC may not be a standalone device separately deployed and installed at the host or target locations. For example, the DSC at the host location, i.e. the client/user side running as a Host Controller, may not be a physically separate device. Instead, a secure connection between the Host Console and the DSM may be made via a secure connection requiring no specialized hardware. In one embodiment, a “softDSC” may be implemented that runs on the local PC or Host Console that includes the functionality as previously described with respect to the DSC operating as a Host Controller.

In one embodiment, the softDSC may include all of the functionality of the DSC Host Controller, as described herein, or a subset thereof, implemented through software that runs on a local PC or equipment at the host location. The software functionality may be installed at the host location utilizing any means known in the art to install software. For example, the softDSC may be downloaded and installed from the internet or may be installed through hardware memory devices, such as CD, DVD, memory stick, etc. The softDSC may also be downloaded to the host location and installed from the DSM after a secure connection is made to the DSM, as described below.

In one embodiment, a connection between the host locations, including the user/client equipment, is made via a secure connection to the DSM, which requires no specialized hardware. Any cryptographic protocol may be used to create the secure connection. For example, Secure Sockets Layer (SSL), and/or Secure Shell (SSH) may be used to provide the secure authentication with any potential encryption algorithm, including Advanced Encryption Standard (AES) or Triple Data Encryption Algorithm (3DES).

Deployment of the present embodiment is simple, including navigating to a website, creating a secure connection (such as through a secure log-in), selecting the target device from an available list presented by the DSM, and then using the remote device as if it were a local device. After the secure connection to the DSM is made, the required applications and/or software, such as the softDSC, may be downloaded and installed or executed on or at the Host Console to perform the functions of the DSC Host Console.

For example, a user browses to a website, such as www.accessmydevice.com. The user is then presented with a secure (SSL) window to enter a Username and Password. After the credentials are verified, the user is redirected to a DSM. An available DSM may be selected through HTML Redirect using a load balancing mechanism which is running on the front end server, as is known in the art.

The DSM then presents the user with a list of available devices. The available devices are those that include a DSC operating as a Device Controller at a Target Location or any other VIP access enabled device. A user then selects the desired device. The DSM establishes a connection to the device at the target location, operating as a Device Controller, associated with the selected device, as described herein. The two connections, between the Host and DSM and DSM to VIP access enabled device at the target location are then bridged together to form the secure tunnel from the Host location to the Target location. The user may then use the device at the Target location as if it were on the local network without having any networking knowledge.

One or more programs or applications may be downloaded and/or executed at the Host Console or user's computer to permit the ultimate secure data transfer through the secure connection between the Host and target VIP access enabled device. For example, the softDSC may be downloaded from the DSM once a user has logged into the DSM. The softDSC may then establish the VIP access via the secure connection, such as SSH, to the DSM. For example, the softDSC may make available a network interface on the local machine via a local interface (127.x.x.x) to originate incoming data streams. The interface is configured to use a Virtual IP address as the entry point to the system, where the VIP is embodied as a local interface (as known in the art) on the Host Console or user's computer, for example 127.0.0.1. Accordingly, all attempts by applications on the Host Console to access the VIP address are automatically and transparently directed to the DSM for handling and transport to the remote VIP access enabled device at a target location by the softDSC through the associated actual IP address.

The interface can accept network requests from applications on the Host console (including, but not limited to for example TCP/IP data streams, individual UDP packets or ICMP control messages). In the case of TCP/IP data streams, to simplify the softDSC functionality, all applications traffic destined for the VIP may be automatically forwarded to the DSM component for processing and routing to the final destination. Therefore, the DSM may perform the three-way handshake needed to establish the TCP/IP session after the softDSC has forwarded traffic to the DSM. In this case, the softDSC, when it receives the initial data packet for the target device will forward the data to the DSM internal VIP (LVIP) via the secure channel. Once the DSM accepts the data on the LVIP, the system performs the MUX handshakes via the softDSC.

The softDSC may include a subset of the full functionality of the DSC as described herein to simplify the softDSC application. For example, the softDSC may be sufficient to establish a single VIP Access connection in one direction, i.e. from the softDSC to the DSM, while the hardware DSC may accept connections from a DSM as well as establish multiple VIP tunnels. If the softDSC only provides the establishment of outbound connections from the Host Location to the DSM, a client viewer may also be used to provide the visual data returned from the Target Location through the DSM. To further simplify the softDSC, other functionality including the device monitoring and traffic monitoring available in the hardware DSC as described herein may not be implemented.

Other applications may also be downloaded and/or executed such as a view client for remote viewing the target device data. In one embodiment, the view client may be used to display data received from the remote device, for example a KVM over IP product, via the established secure tunnel. For example, a client view application may be delivered from the DSM and launched on the Host Console or user's PC after the secure tunnel is created. The client view application may be redirected to an IP/Port on the local machine. The softDSC may then take and virtualize that local connection securely across the internet to the VIP access enabled device, as described above.

For example in one embodiment, when an application accesses the localhost port, where xxx is the local port address which is linked to the VIP access enabled remote device, the softDSC forwards the data to the DSM (LVIP) via the secure channel. Once the DSM accepts the data on the LVIP, the system performs MUX handshakes via the softDSC. After the MUX handshake is successfully completed, the DSM sends a request to the internal DEMUX port and forwards the data to the port of the VIP access enabled target device, which is already registered as a VIP access enabled device on the DSM web and bootstrapped. A user then gains access to the target network and all data is transferred via secure channels and for example in one embodiment, it is viewed through the downloaded client view.

In another embodiment, the softDSC runs within a virtual computer environment. For example, the application of the softDSC may run on a virtual computer or an application server such as a J2EE container.

One alternative may be to have the softDSC functionality on a virtual computer, such as that supplied by Amazon “EC3 Elastic Cloud.”

The DSC at the remote location operating as a Device Controller may also be physically removed. The features as described with respect to the DSC operating as a Device Controller may be included directly into the target devices, obviating the need for the separate DSC device. Accordingly, the functionality, as described herein, becomes an integral part of the target product (for example the Lantronix Xport PRO, EDS1100, etc.).

Referring to FIG. 6, the DSM 610 provides centralized administration of the distributed system of DSC across the wide area network and proxy communications between those DSCs. An administrator with a GUI 651 from the DSM 610 creates a full device configuration record in Central Registry 620 from the initial configuration file with additional information including making pair associations of an existing device configuration with a specific discovered device, persistent state information, etc. The Central Configuration Registry 620 stores the configuration information and the user data replication manager makes a master copy of the device configuration file stored in the DSM 610.

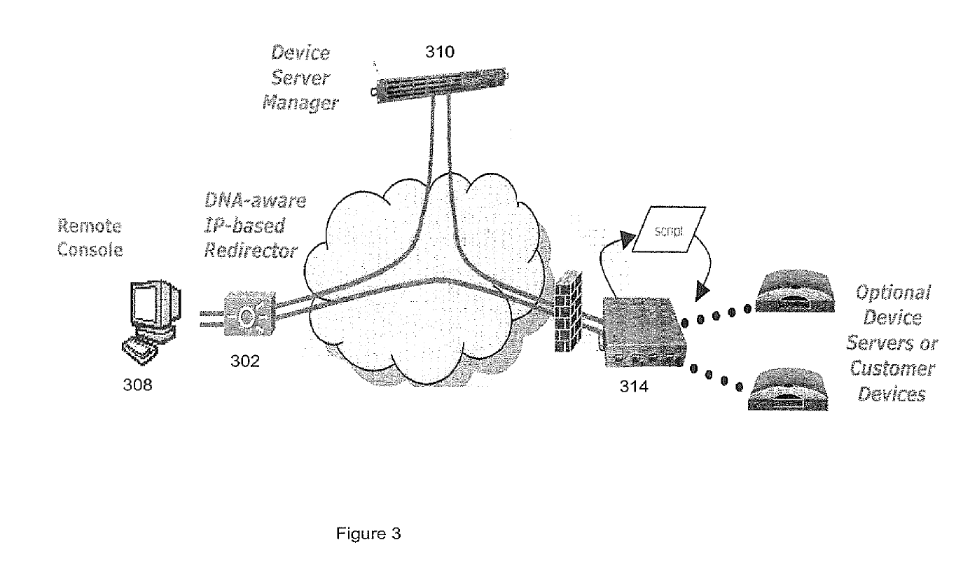

FIG. 3 illustrates a block diagram of an embodiment of a system having a central DSM and local DSCs to access to and from networked devices in networks protected by firewalls. The virtual device network is created by the DSM 310 and DSCs 302, 312 and the network devices associating with each DSC. The VDN in FIG. 3 operates similarly to the above descriptions for FIGS. 1, 2a, and 2b except where noted. The IP redirector may have portions resident in both the DSC and the DSM.

Referring to FIG. 7, the IP redirector may include the access subsystem device management system and registry. The Conduit Manager 724 in the DSC notifies local DSC processes that the SSH session to the DSM has been fully established. The conduit's SSH shell session is attached to the IP redirector program portion in the DSM. The IP redirector program then sends periodic beacon packets that the DSC can use to ensure the direct communication tunnel is established and active. Some minor protocol capabilities may be present to allow the DSC/DSM 110 to perform bandwidth/latency estimates. SSH's TCP port-forwarding feature can be used to pass all other control and tunnel data between the DSM and DSC. The Conduit Manager 724 may also negotiate the “remote” port so that it can listen in from the DSM.

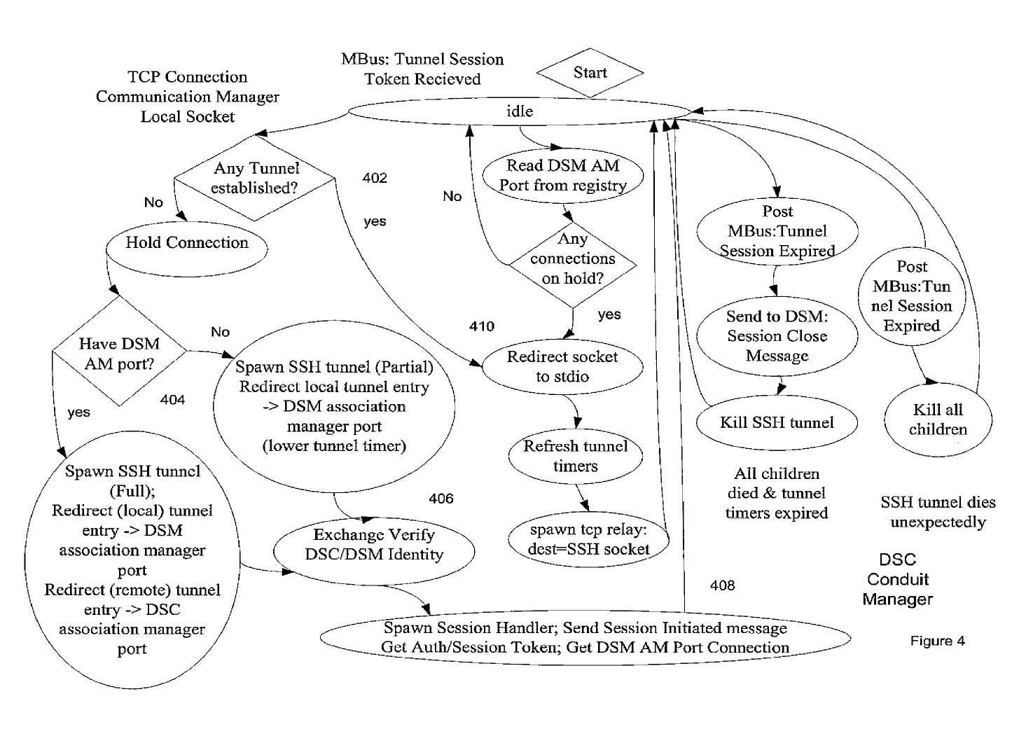

FIG. 4 illustrates a state diagram of an embodiment of the Conduit Manager in the DSC. The Conduit Manager contains code to start and stop the direct TCP communication tunnel, and determine when this direct TCP communication tunnel is idle or unexpectedly interrupted, etc. In block 402, when a pending TCP connection request comes in, the Conduit Manager checks to see if any SSH tunnel is already established with the DSM. If not, in block 404, the Conduit Manager establishes a full or partial SSH session. In block 406, the Conduit Manager negotiates authentication of that DSC with the DSM by each verifying their identity.

After the SSH session has been fully established and an identity of the DSC responsible for the point of origin is authenticated with the DSM, then in block 408 traffic is allowed to pass in both directions in the direct communication tunnel.

In block 410, if the tunnel has already been established, the DSC redirects the socket and refreshes the tunnel timer.

Referring to FIG. 6, the DSM 610 has an IP redirector program that consists of multiple routines implemented in software, logic or a combination of both. The DSC may also contain a portion of the IP redirector program. The IP redirector program may include portions in the DSC such as the Conduit Manager in the DSC, which has code scripted to provide basic secured network communication and manage the conduit tunnel between a DSC and the DSM and the Tunnel Manager in the DSC.

The Tunnel Manager 624 portion of the IP redirector in the DSM 610 has code scripted to provide a secured multiplexed TCP session between the DSM and a DSC operating in DEMUX mode and the DSM and a DSC operating in MUX mode.

The above processes may be implemented by software code written in a given programming language, hardware logic components and other electrical circuits, or some combination of both.

Accordingly, in an embodiment, the software used to facilitate the algorithms discussed above can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; Digital Video Disc (DVD's), EPROMs, EEPROMs, FLASH memory, magnetic or optical cards, or any type of media suitable for storing electronic instructions.

Some portions of the detailed descriptions above are presented in terms of algorithms and symbolic representations of operations on data bits within a computer's memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers, or other such information storage, transmission or display devices.

In an embodiment, the logic consists of electronic circuits that follow the rules of Boolean Logic, software that contain patterns of instructions, or any combination of both.

While some specific embodiments of the invention have been shown, the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

What is claimed is:

1. An apparatus, comprising: a soft Distributed Services Controller (DSC) having a first Conduit Manager to create a first outgoing TCP/IP stream connection associated with a first virtual IP address to a device service manager (DSM), which in turn relays communication traffic from the first outgoing TCP/IP stream connection to a second DSC, which has a second Conduit Manager to create a second direct outgoing TCP/IP stream connection associated with a second virtual IP address to the DSM, where the soft DSC is implemented as software and executed at a first local network and the second DSC resides in a second local network distinct from the first local network and the DSM resides in a wide area network.

2. The apparatus of claim 1, wherein a secure connection is created between the first local network and the DSM and the soft DSC is executed at the first local network to receive communication traffic on a first virtual IP address and route that communication traffic onto the DSM over the secure connection.

3. The apparatus of claim 2, wherein the VIP Access enabled device receives communication traffic from the DSM directed at the second VIP and routes that communication traffic onto a destination device also connected to the second local network that the VIP Access enabled device is part of.

4. The apparatus of claim 3, wherein the first outgoing TCP/IP stream connection is created when the soft DSC forwards data directed at a local host port to an internal VIP of the DSM, the DSM accepts the data on the internal VIP, and MUX handshakes are performed via the soft DSC.

5. The apparatus of claim 4, wherein the VIP Access enabled device establishes the second outgoing TCP/IP stream connections to the DSM by periodically authenticating itself to the DSM and then keeping that connection open for future bi-directional communication on the outgoing TCP/IP stream connection, and wherein an IP redirector in the DSM receives communication traffic from the first established TCP/IP stream connection from the first DSC and then routes the communication traffic down the second established TCP/IP stream connection to the VIP Access enabled device based on Virtual IP address mapping occurring in the registry of the DSM.

6. The apparatus of claim 4, wherein the soft DSC is downloaded from the DSM and executed on a local PC connected to the first local network.

7. The apparatus of claim 4, further comprising:
a firewall protecting the second local network, wherein a host console initiating the communication traffic to a remote target device in the second local network executes the soft DSC on the first local network, in which a tunnel manager program in the soft DSC forwards the communication traffic to the DSM, and
the DSM maps the first outgoing TCP/IP stream connection to a corresponding virtual IP address and port associated with the VIP Access enabled device, where the IP redirector of the DSM determines an intended target device address to a target device in a subset of equipment in a second network and information associated with the VIP Access enabled device in the second network by consulting a routing table that stores at least real IP addresses, virtual IP addresses, routes to the subset of equipment, and then forwards packets to the VIP Access enabled device through the second outgoing TCP/IP stream connection established with the VIP Access enabled device.

9. The apparatus of claim 4, wherein a tunnel manager program in the soft DSC adds onto a header of the communication traffic, information that includes: 1) that the communication traffic is coming from the soft DSC and 2) identifying information on the originating device in the first local network by including both the source device and port originally sending the communication traffic, and then forwarding the communication traffic to the DSM for routing over the Internet.

10. The apparatus of claim 1, wherein a tunnel manager is configured for the soft DSC to be able to initiate a TCP or UDP connection to an end target device in the second local network protected by an intervening firewall and without knowing the real IP address of the end target device, wherein the soft DSC uses the local host port as the VIP Access entry point. 11.12.13. The apparatus of claim 1, wherein the soft DSC runs within a Virtual computer environment.

14. A method, comprising:
creating a first secure connection between a host device residing in a first local network and a central device residing in a wide area network external to the first device;
selecting a target device residing in a second local network distinct from the first local network to create a secure tunnel with the first local network;
downloading over the secure connection an application, or applications to the host device;
executing the application on the host device to establish a first outgoing TCP/IP stream connection from the first local network to the central device on the wide area network;
establishing a second outgoing TCP/IP stream connection to the central device from the target device, where the target device creates the second outgoing TCP/IP stream connection to the central device by periodically authenticating itself to the central device and then keeping that connection open for future bi-directional communication on an outgoing TCP/IP stream connection;
using a first virtual IP address on the host device and a second virtual IP address to the target device; and
receiving communication traffic from the first established TCP/IP stream connection from the host device associated with the first virtual IP address and then routing the communication traffic down the second established TCP/1P stream connection to the target device associated with the second virtual IP address based on virtual IP address mapping occurring in a registry of the central device.

15. The method of claim 14, further comprising downloading a viewing application for displaying data received from the target device at the host device on the first local network.

16. The method of claim 15, further comprising:
launching the viewing application on the Host Console or users PC on the first local network;
redirecting the viewing application to an IP/Port on the host device creating a local connection; and
virtualizing the local connection securely across the secure connection to the central device.

17. The method of claim 14, wherein the application is executed so that the application runs within a Virtual computer environment to establish a first outgoing TCP/IP stream connection from the first local network to the central device on the wide area network.

18. A system, comprising:
a soft Device Services Controller (DSC), implemented in software, downloaded to a Host Console or User's PC on a first local network from the device service manager (DSM) on a wide area network, and executed at a first local network, wherein the soft DSC is executed to implement a virtual network interface and corresponding virtual IP address (VIP) to permit outgoing TCP/IP conduit connection to the DSM by creating a first outgoing TCP/IP stream connection from the first local network to the DSM on the wide area network; the soft DSC configured to automatically process and forward networking traffic arriving at the virtual networking interface with the associated VIP to the DSM; and
a VIP Access enabled device on a second local network distinct from the first area network; wherein the VIP Access enabled device periodically authenticates itself to the DSM and establishes an outgoing TCP/IP stream connection to the DSM and then keeps that connection open for future bi-directional communication on the outgoing TCP/IP stream connection; and
an IP redirector in the DSM receives communication traffic from a first established TCP/IP stream connection from the softDSC and then routes the communication traffic down the second established TCP/IP stream connection to the VIP Access enabled device based on VIP address mapping occurring in a registry of the DSM, wherein the VIP Access enabled device decodes the communication.

19. The system of claim 18, wherein the DSM has a virtual IP address routing table in the registry of the DSM that stores at least real IP addresses of each DSC or VIP Access enabled device, the network devices on that local area network, which are designated as visible by a user of the local area network, the virtual IP addresses, routes to devices, where the DSM uses the information in the virtual IP address routing table to map a virtual IP address assigned by the DSM to a real IP address associated with a given DSC or VIP Access enabled device to establish the route and the DSM determines an appropriate virtual IP address route by referencing the virtual IP address routing table, and then forwards the communication traffic to the VIP Access enabled device for delivery to the target device.

20. The system of claim 19, wherein the DSM determines the appropriate VIP route by referencing the VIP Routing Table and seeing that the target device's real IP address is associated with the VIP Access enabled device's unique ID and that a unique ID of the VIP Access enabled device is associated with a given virtual IP addresses.
